(19) United States
(12) Patent Application Publication
(10) Pub. No.: US 2005/0123192 A1
(43) Pub. Date: Jun. 9, 2005

(54) System and method for scoring presentations

(76) Inventors: David H. Hanes, Loveland, CO (US); Kimberly L. Burch, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/729,129

(22) Filed: Dec. 5, 2003

(51) Int. Cl. G06K 9/00

(52) U.S. Cl. 382/164; 382/165

(57) ABSTRACT

Disclosed are systems and methods for scoring presentations comprising capturing data forming at least a part of a particular presentation of the presentations, electronically analyzing the captured data to determine variations from accepted criteria, and scoring the captured data based on deviations from the accepted criteria.

### BACKGROUND

There is a desire among electronic presentation creators, such as video camcorder users, digital camera users, electronic slide show creators, etcetera, to store their recorded presentations onto a more permanent and/or convenient medium, such as a recordable digital versatile disk (DVD), or hard drive of a personal computer (PC). Such media has the benefit of longevity and is durable, randomly accessible, and searchable.

In some instances, it is desirable to edit the recorded data to further improve the viewing experience. Unfortunately, some users may have limited experience with editing audio and/or video, and the resulting presentation is often unsatisfying, especially when compared to professional grade creations. Some of the common user mistakes are: the use of too many transitions; video segments that are too long; mismatched or missing audio; and video transitions that are not in synchronization with music or other audio features.

### SUMMARY

In one embodiment, a method is provided for scoring presentations comprising capturing data forming at least a part of a particular presentation of the presentations, electronically analyzing the captured data to determine variations from accepted criteria, and scoring the captured data based on deviations from the accepted criteria.

### BRIEF DESCRIPTION OF THE DRAWINGS

FIG. 1 is a flow diagram of an embodiment illustrating the provision of advice to a user;

FIG. 2 is a flow diagram of an embodiment of a summary analysis module;

FIG. 3 is a flow diagram of an embodiment of a change mode module; and

FIG. 4 shows one embodiment of a system in which embodiments of the present invention may be implemented to advantage.

### DETAILED DESCRIPTION

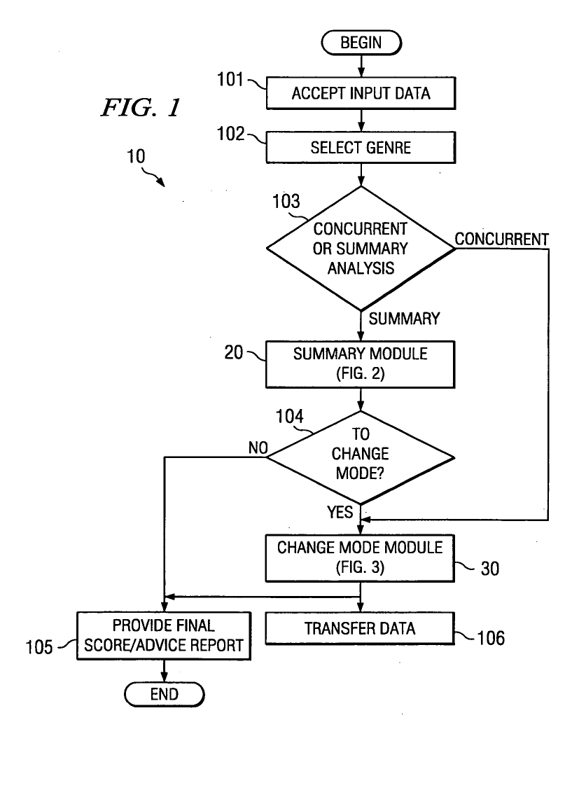

FIG. 1 shows flowchart 10, which is an embodiment illustrating the provision of advice to a user with respect to a presentation, such as may comprise an audio/video composition (e.g., camcorder video stream), a multimedia project (e.g., combination of images and sounds), and/or other electronic or digital content. Process 101 could start, for example, when a user is transferring video from one medium to another. Process 101 could also, for example, start when the user is creating a multimedia project starting from an analog or digital video recording or other data input. After data is input, as shown in process 101, the user is (optionally) prompted in process 102 to select a genre. The genre may be selected from categories, such as drama, action, comedy, family movies, or user-defined categories, to name only a few examples. The genre selection identifies parameters, such as an acceptable or optimal number of transitions or acceptable segment lengths (e.g., a maximum number of scene transitions per minute, as average scene length, etcetera), as appropriate for that genre. The genre selection may also identify and/or suggest possible sound effects and background music selections that have previously been used or that are available in a library database or other resource. The genre selection enables more precise advice for the user, and enables such advice to be based on the type of presentation the user wishes to create. The genre selection of parameters can be, for example, from a file library, database, or contained on a disk, or entered using a keypad or voice-controlled device.

Process 103 queries whether the user wishes to use concurrent or summary analysis. Concurrent analysis of the illustrated embodiment enables an interactive session wherein changes may be made to the presentation as the analysis occurs. Summary analysis of the illustrated embodiment enables a batch session wherein a complete analysis of all parameters is made first and a report is provided to the user. The report would contain advice that the user could use to make subsequent changes to the presentation.

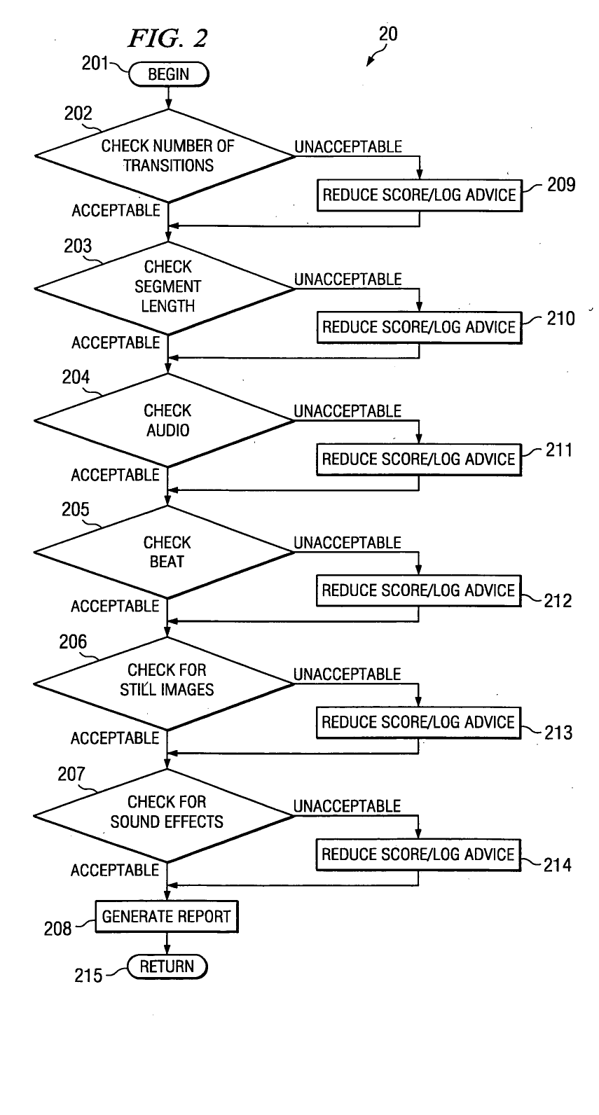

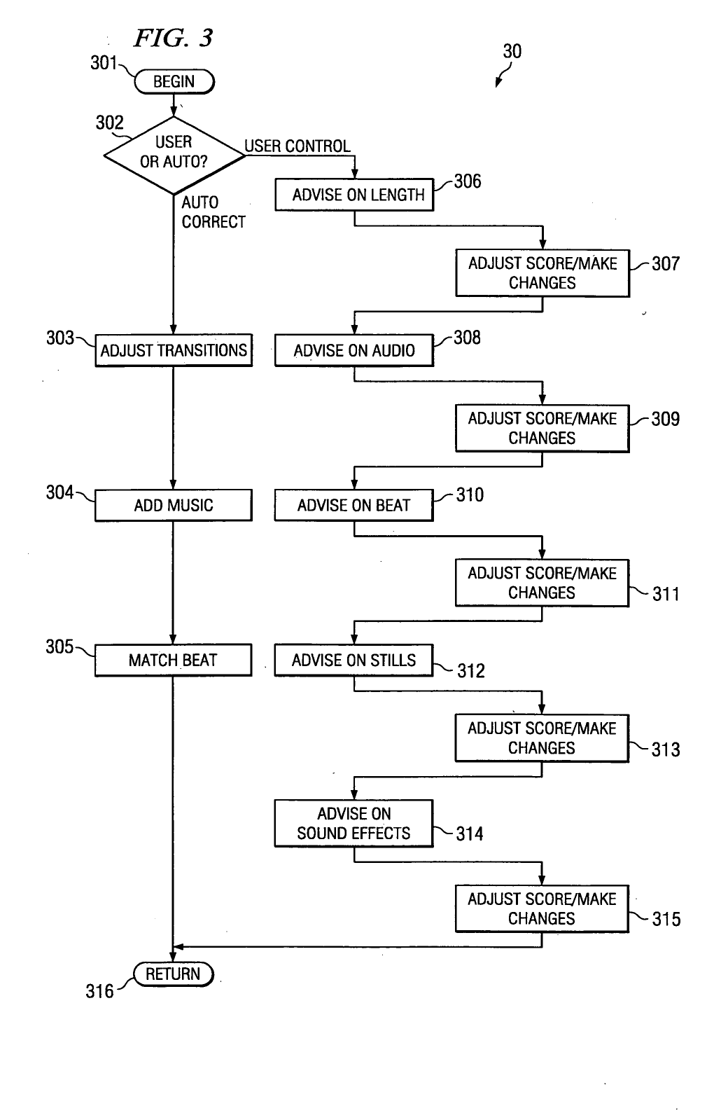

If the user selects summary analysis at process 103, summary module 20 is entered, an embodiment of which is further described with respect to FIG. 2. After the application of the summary analysis, process 104 queries whether the user would like to initiate the change mode to make changes based on an advice report from the summary analysis. If the user selects change mode at process 104, change mode module 30 is entered, an embodiment of which is further described with respect to FIG. 3. However, if the user does not select change mode at process 104, a final score and/or advice report is provided by process 105.

If the user selects concurrent analysis at process 103 or change mode at process 104, change mode module 30 is entered. After application of the change mode, process 106 prepares the presentation data, as changed, for storage and a final score and/or advice report is provided by process 105.

Process 105 of one embodiment provides a score and comparison of previously stored scores of that user (or scores between and among other users) to the user. A score report may also be provided to indicate to the user the level of proficiency that has been achieved. The report, if desired, can provide suggestions for future improvement and praise for increased levels of proficiency, praise for accepting suggestions, and the like. Whether or not the change mode is used, the score report can be confined, if desired, to comparisons within multimedia projects of the same genre.

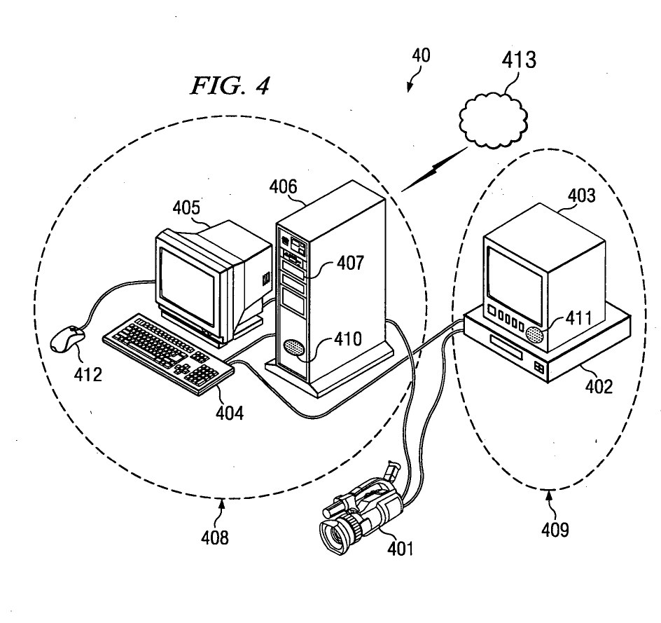

Storage of the presentation, such as by transfer of the data to a selected medium, provided by process 106 may be a more permanent storage medium than had been used for the original input data or could be the same storage medium as originally used. Process 106, if desired, could control recording on several storage media concurrently and one or more of these media could be remotely located and accessible, for example, via network 413, FIG. 4. Also note that the corrected presentation can be streamed to the permanent storage medium as changes are made, rather than in a batch transfer.

Directing attention to FIG. 2, flow diagram 20 provides a summary analysis and/or advice report for a presentation according to an embodiment of the present invention. Process 201 is the interface from decision point 103 (FIG. 1).

At process 202, the number of transitions is checked against a pre-set range for the selected genre. Such analysis may, if desired, depend upon the overall length of the video because a shorter presentation will usually have a lower number of acceptable transitions compared to a longer presentation. One technique for detecting transitions is by using a video editor program to count the number of transitions in the subject presentation. If the transition analysis occurs after the project has been rendered into a video file/stream, then the transition detection becomes more difficult. In such a situation, the video stream may be analyzed frame by frame, looking for frames that look like transitions, such as fades or where a large percentage (e.g., 85%) of pixel values change between frames.

Additionally or alternatively, transitions may be checked using other criteria, such criteria as the speed or duration of the transitions, the types of transitions, the types of presentation segments being transitioned between, and/or the like. If the transitions are outside of a predetermined range or threshold of one or more of the criteria, process 209 reduces the user's score and advice is logged regarding transitions.

Advice logged at process 209 may, for example, include adding or removing transitions, reducing or increasing the duration of the transitions, using more or less of a particular type of transition or reducing or increasing the variety of transition types used, avoiding transitions between particular types of presentation segments, etcetera. The advice may, additionally or alternatively, provide more general advice on transitions, such as what they are and how to avoid them.

If the number of transitions is acceptable, or within the range provided by the genre (or after the score is decreased and the advice is logged at process 209), process 203 checks the segment lengths against the parameters for the selected genre. If the segment lengths are found to be unacceptable, such as being outside the predetermined ranges, process 210 reduces the user's score and logs advice appropriate to correct the segment lengths. The advice, for example, may include suggestions to lengthen or shorten the segments.

After process 210, or if the segment length is found to be acceptable at process 203, process 204 checks the audio portion of the presentation (if the selected genre provides for audio). The audio check may include, for example, detecting the types of audio that are used in the presentation or checking for too many audio clips within segments as compared to parameters pre-stored for that genre. If the audio check returns an unacceptable response, process 211 reduces the user's score and logs appropriate advice.

After process 211, or if the audio check of process 204 returns an acceptable response, process 205 checks the beat of the audio. This beat check may include, for example, making sure that the video transitions match the beat of music. If the beat check of process 205 returns an unacceptable response, process 212 reduces the user's score and logs appropriate advice. The advice may include, for example, suggesting that the user match the appropriate beat in the transition and explaining how that can be accomplished. If the beat check returns an unacceptable response, an option is to enable a user to observe the beat on a visual display, or to hear the beat through a speaker or headphones.

After process 212, or if process 205 returns an acceptable response from the beat check, process 206 checks for still images. Process 206 compares the use of still images in the multimedia project with acceptable parameters for the selected genre. For example, criteria such as the number of still images present, the duration of display of still images, and the transition between still images (e.g., the duration, the type, the variety, and/or the number of transitions) may be utilized in analyzing the use of still images in a presentation. If the use of still images is unacceptable, the user's score is reduced and the appropriate advice is logged at process 213. The advice may include, for example, suggestions with respect to: adding or subtracting a number of still images, freezing frames of visual input to serve as a transition, casting the presentation in a different genre, or adding other parameters.

After process 213, or if process 206 returns an acceptable response, process 207 checks for sound effects as acceptable for the selected genre. For example, the use of sound effects with respect to a particular genre may be determined to be unacceptable. Additionally or alternatively, criteria such as the volume, the tenor or type, the spacing, and/or the number of sound effects, may be utilized in analyzing the sound effects in a presentation. If the use of sound effects is acceptable, process 208 provides the user's score and any other pertinent advice pertaining to the presentation. If the use of sound effects is not acceptable, process 214 reduces the user's score and logs the appropriate advice for a more proper use of sound effects for that genre.

After process 214, process 208 generates a report to the user. The report, for example, would include the user's score and advice for generating a higher quality presentation as may be compiled from the scoring and advice logging of processes 209-214 discussed above.

Process 215 returns the user to process 104 in FIG. 1 where the user may implement the changes suggested in summary mode, or may go to change mode 30, as further described with respect to FIG. 3.

Directing attention to FIG. 3, flow diagram 30 provides concurrent analysis, for a presentation according to an embodiment of the present invention. Process 301 is the interface from decision point 103, or from decision point 104 (FIG. 1). Process 302 queries whether the user would like the changes to be made automatically or individually implemented under control of the user. Note that decision point 302 is optional and the system can be designed for either automatic correction or user controlled correction, or both, as shown.

If the user selects the automatic correct mode at decision point 302, process 303 adjusts transitions, process 304 adds music and other audio effects from choices allocated to the selected genre, and process 305 matches the beat of audio selections with the transitions and other major events in the presentation, such as presentation beginning and ending, changes in types or formats of content presented, etcetera. These adjustments are made according to the analysis discussed above with respect to summary module 20, except that the changes would be made according to one embodiment without first generating a report to the user.

Other steps may also be implemented in the automatic change mode, such as, for example, adjusting audio volume levels and freezing shots of the visual input to act as still images.

If the user selects the user control mode at decision point 302 to implement suggested changes, process 306 gives advice on segment length and the number of transitions. Process 307 adjusts the user's score and enables the user to direct which changes are to be made. The score reflects the user's implementation of suggestions, and points may be subtracted based on poor implementation or added based on good or improved usage of the multimedia tools. Thus, if a user makes changes to the presentation that are different from the changes that were suggested, the actual changes are graded and points added or subtracted from the user's score as appropriate. Alternatively, the user may opt to make different changes, or not to make any changes.

Process 308 advises on the audio portion of the presentation, such as the audio quality, the amount of audio used, and the variety of the audio used. Acting on the advice offered in process 308, process 309 adjusts the user's score and allows for implementation of the changes in the same manner as discussed with respect to process 307 above.

Process 310 offers advice on matching the beat of the music to the transitions, to the genre, etcetera. The user's score is adjusted and changes may be implemented by the user at process 311.

Process 312 provides advice on the use of still images. According to the genre selected, many or few stills are suggested as appropriate. Process 313 adjusts the score and implements the user's changes.

Process 314 analyzes the presentation and provides advice on the use of sound effects. Advice on sound effects may include the use of more or less sound effects, depending upon the genre selected, as well as advice about which sound effects might be appropriate for the selected genre. Process 315 adjusts the user's score and implements the user's changes. Process 316 returns back to flowchart 10 at process 105 and 106 of FIG. 1, where, in process 105, the final score and report are provided to the user and in process 106, the changed data is transferred for storage.

Note that other analysis for FIGS. 1, 2, or 3 may be implemented with the addition or substitution of different modifications and add-ons as decided upon by a user. These additional or alternative analyses, or implementation arrangements may be included in the original program and simply selected when desired or they may be added from time to time. For example, different software modules, or programs, can be added to computer system 408 (FIG. 4) from time to time, as desired. These modules might contain, for example, different parameters for each genre, or new or different genres and may contain new audio or audio parameters as guidelines change.

FIG. 4 depicts system 40 representing one exemplary embodiment of the present invention. System 40 shows video camcorder 401, video cassette recorder (VCR) 402, television 403 (containing audio speaker 411), computer 406, such as may comprise a central processing unit, memory, input/output interfaces, and central algorithms, digital versatile disk (DVD) writer 407, computer monitor 405, computer speaker/microphone (or an external speaker/microphone depending upon the particular computer model) 410, computer mouse 412, and computer keyboard 404. DVD writer 407 is shown disposed within computer 406 although DVD writer 407 may be completely external as a stand alone device. Computer 406, DVD writer 407, monitor 405, and keyboard 404 are referred to herein as computer system 408, which in other embodiments may not have all of these components or may have other components. Television 403 and VCR 402 are referred to herein as television system 409.

In one embodiment, camcorder 401 is connected to television system 409 to allow the user to view the presentation as it is being edited, if desired. Camcorder 401 is also connected to computer system 408 to provide access to editing tools as well as to provide storage for the video and/or audio portions of the presentation. DVD writer 407 enables the presentation to be stored on DVD media (not shown) under control of the system and methods discussed above. Note that the storage of the presentation can be on any medium, including a hard drive of computer 406. Software or programs for controlling and/or monitoring embodiments of the present invention can be stored on the hard drive of computer 406, or on a portable memory, such as a disk, or on a combination thereof. Note also that although a camcorder is shown, any device for producing a series of images can be used. For example, web cams or still cameras that store short video clips can be used, as well as slide projectors or slide readers for ‘still’ pictures.

Computer software containing the control program including, if desired, the embodiments of FIGS. 1-3, may be loaded onto computer system 408 in order to implement and evaluate a user's changes to a presentation. Each stage of a project, including the final product, may be viewed using computer system 408 via computer monitor 405. As discussed, the multimedia project data may be recorded onto DVD media via DVD writer 407, or stored on computer 406 to make editing and access of the presentation easier. Computer system 408 may be interfaced with television system 409 to enable viewing on television 403 through direct use or use in conjunction with VCR 402 during and after editing on computer system 408.

The advice provided to the user may be given visually, or textually, through computer monitor 405, or via television monitor 403, using symbols or words respectively. The advice may also be provided audibly through speakers 410 on computer system 408, or via speakers on television 411. User interface may occur through the use of touch screen buttons on accommodating computer models, or through keyboard 404, mouse 412, or any other input device, such as a joystick, or voice-to-data conversion applications using, for example, speaker/microphone 410. Computer system 408 may also be connected with other computer systems, or a server via network 413, in order to provide control for computer system 408. Some or all of the control logic could be via network 413 to enable access from servers located at multiple locations.

1. A method for scoring presentations, said method comprising:
capturing data forming at least a part of a particular presentation of said presentations;
electronically analyzing said captured data to determine variations from accepted criteria; and
scoring said captured data based on deviations from said accepted criteria.

2. The method of claim 1 further comprising:
providing a report for improvement of said particular presentation, said report based upon said electronically analyzing said captured data.

3. The method of claim 2 wherein said scoring is based, at least in part, on a user elected implementation of advice provided in said report.

4. The method of claim 1 further comprising:
electronically correcting said particular presentation based upon results of said electronically analyzing.

5. The method of claim 4 further comprising:
transferring said captured data from one medium to another medium after said electronically correcting.

6. The method of claim 4 wherein said electronically correcting occurs through use of at least one user interface selected from the group consisting of: a computer monitor touch-screen, a computer keyboard, a computer mouse, a computer joystick, a verbal command, and a textual command.

7. The method of claim 1 wherein said electronically analyzing comprises:
determining at least one criteria from the group consisting of: a number of transitions, a segment length, use of audio, beat matching with transitions, use of still images, and use of sound effects; and
comparing determined ones of said criteria against an acceptable range of previously set parameters.

8. The method of claim 1 wherein said particular presentation is a multimedia presentation.

9. The method of claim 1 further comprising:
providing comparative improvement scores based upon previously stored scores.

10. The method of claim 1 wherein said electronically analyzing comprises:
comparing said data against a set of genre criteria, said genre selected from the group consisting of: drama, action, comedy, family movies, and a user-defined category.

11. The method of claim 1 further comprising:
providing a summary report of advice based on evaluations selected from the group consisting of: number of transitions, segment length, use of audio, audio beat matching with transitions, use of still images, and use of sound effects.

12. A system comprising:
means for storing electronic content;
means for comparing elements of said electronic content with pre-defined parameters; and
means for providing a report containing results of said comparison.

13. The system of claim 12 wherein said electronic content comprises video and said report includes suggestions selected from the group consisting of: number of transitions, segment length, use of audio, audio beat matching with transitions, use of still images, and use of sound effects.

14. The system of claim 12 wherein said report includes specific instructions for improving a score for a presentation of said electronic content.

15. A computer program product having computer readable code stored on a computer readable medium, said computer program product comprising:
code for controlling the acceptance of data pertaining to a presentation;
code for controlling a comparison of elements contained within said presentation to pre-defined criteria; and
code for presenting scores to a user, said scores based upon said comparison of elements to said pre-defined criteria.

16. The computer program product of claim 15 further comprising:
code for enabling said user to accept presentation modification suggestions.

17. A method comprising:
selecting a genre for a presentation stored in a digital medium;
identifying pre-defined parameters with the selected genre;
comparing data of the presentation with the pre-defined parameters for the selected genre; and
generating a report of the comparison between the data of the presentation and the pre-defined parameters.

18. The method of claim 17, wherein said presentation comprises video and audio.

19. The method of claim 17 further comprising suggesting at least one of sound effects and background music for the presentation based on the selected genre.

20. The method of claim 17 further comprising storing the pre-defined parameters in a database.
